(19) United States
(12) Patent Application Publication
(10) Pub. No.: US 2006/0020048 A1
(43) Pub. Date: Jan. 26, 2006

(54) Polyurethane-containing building materials

(76) Inventor: Kevin John O'Kane, Felton Bristol (GB)

Correspondence Address: PEARNE & GORDON LLP, 1801 EAST 9TH STREET, SUITE 1200, CLEVELAND, OH, 44114-3108, US

(21) Appl. No.: 10/526,890

(22) PCT Filed: Sep. 4, 2003
(86) PCT No.: PCT/GB03/03844

§ 371 Date: Apr. 29, 2005

(30) Foreign Application Priority Data
Sep. 4, 2002 (GB) 0220510.2

(51) Int. Cl. C08G 18/48

(52) U.S. Cl. 521/99

(57) ABSTRACT

Concrete containing polyurethane is provided and construction elements comprising such concrete. Methods for the preparation of polyurethane powder for inclusion in such concrete and for the formation of construction elements comprising such concrete are also provided.

### TECHNICAL FIELD

This invention relates to building materials, particularly concretes containing polyurethane, and panels comprising such building materials. The invention also relates to methods or preparing such building materials.

### BACKGROUND ART

Panel boards are by used during the construction of buildings to form the surface of walls, floors and ceilings. Such panels generally comprise a core material sandwiched between two layers of covering material. Plasterboard is a commonly used example of a panel board, comprising hardened plaster niched between two layers of card. Panel boards may also have plywood cores. In parts of a building which come into contact with water, for example bathrooms, panel boards may be used which could typically comprise gypsum-based plasterboard or a cement-based board sandwiched between two layers of mesh.

Several manufacturers have developed the construction of these basic panel board products using materials other than concrete to make them more lightweight than boards of traditional construction. For example, U.S. Pat. No. 0,082,365 discloses a lightweight board comprising a polyisocyanurate or polyurethane foam core with lower and upper surfaces and filler material such as wood chips within the foam core. The board is intended primarily for use as an insulator in roof construction.

Marmox® (Marmox (UK) Ltd, Rochester, Kent, UK) is a lightweight unfinished board product which comprises extruded polystyrene with a fibreglass reinforced face set in a cement polymer adhesive. It is sufficiently strong to be suitable for the construction of walls and floors. The surface will accept both plaster and paint, or tiles to provide a finished surface. Marmox boards are also waterproof and therefore suitable for use in moist areas such as bathrooms.

Other panels include Aquapanel® which is a building board composed of cement and reinforced with glass fibre mesh. Respatex® and Wetwall™ are both board products comprising a plywood core and laminate faces, suitable for wall cladding only.

Polyurethane (PUR) is an artificial material which is used in rubber form, in sealants and in a rigid foam form as insulation for, amongst other things, refrigeration units. The blowing agents used to generate the foam structure in PUR foam have traditionally been chlorofluorocarbons (CFCs). The environmental consequences of the release of CFCs when a refrigeration unit is broken up at the end of its life are well known. Less widely publicised, however, arm the consequences of the disposal of the remaining PUR foam waste, which often ends up in landfill sites. It is preferable to recycle such waste in order to minimise the volume of such material which ends up in landfills.

### DISCLOSURE OF INVENTION

According to a first aspect of the invention there is provided concrete comprising PUR. The concrete may comprise a binding agent, water and PUR. The PUR may preferably be PUR foam. The binding agent may be cement or gypsum. Examples of suitable cement include, but are not restricted to, Ordinary Portland Cement, Rapid Hardening Port Cement, Sulphate Resisting Portland Cement and other Portland Cements containing various additives. Examples of suitable gypsum-based products include, but are not restricted to, Gyproc®, Gyplite® and Blue Hawk®. In a preferred embodiment, the concrete may further comprise at least one bulking agent, waterproofing agent and/or flowing agent. The bulking agent may be limestone dust or silica sand. The waterproofing agent may be Xypex® admix C-1000 (Xypex Chemical Corporation, Canada) or Hydrophobe™ (WR Grace & Co., Cambridge, United Kingdom). The flowing agent may be an air entrainer, for example, Airalon™ (WR Grace & Co.).

Preferably, the concrete according to the invention may comprise:

| | |
|---|---|
| Cement | 240-450 kg/m³ |
| PUR | 200-395 kg/m³ |
| Bulking agent | 0-300 kg/m³ |
| Waterproofing agent | 0.1-0.3% w/w cement |
| (Hydrophobe) | |
| Flowing agent | 0.03-0.06% w/w cement |
| (Airalon) | |
| Water | 160-450 l/m³ |

Most preferably the concrete according to the invention may comprise:

| | |
|---|---|
| Cement | approx. 375 kg/m³ |
| PUR | approx. 250 kg/m³ |
| Bulking agent | approx. 250 kg/m³ |
| Waterproofing agent | 0.1-0.3% w/w cement |
| (Hydrophobe) | |
| Flowing agent | 0.03-0.06% w/w cement |
| (Airalon) | |
| Water | approx. 200 l/m³ |

Alternatively, the concrete according to the invention may comprise:

| | |
|---|---|
| Cement | approx. 300 kg/m³ |
| PUR | approx. 327 kg/m³ |
| Waterproofing agent | 0.1-0.3% w/w cement |
| (Hydrophobe) | |
| Flowing agent | 0.03-0.06% w/w cement |
| (Airalon) | |
| Water | approx. 373 l/m³ |

There is further provided a panel board comprising concrete according to the first aspect of the invention.

It is an advantage of the current invention that, as the result of the replacement of at least some of the usual sand bulking agent with PUR foam, the resistant concrete may be used to form panel boards which are lightweight compared with traditional concrete panel boards. The PUR-containing concrete panel boards are strong enough to be used in the construction of walls and floors and also can be waterproof such that they can be used to form walls in moist areas such as bathrooms.

According to a second aspect of the invention, there is provided a method for preparing dried expanded PUR foam for use in the preparation of concrete, comprising:
a) soaking granulated PUR foam in water for a period of time sufficient to allow the PUR to expand,
b) separating the PUR from the water; and
c) drying the PUR.

It is a further advantage of this aspect of the current invention that the granulated PUR foam is pre-expanded by the soaking treatment, hence allowing it to stabilise, eliminating the risk of further expansion on addition of the remaining water and cement during mixing of PUR-containing concrete.

The water may be between pH 6 and pH 9. Preferably the water may be potable. The granulated PUR foam may be soaked in water for between about ten minutes and about two days, preferably for between about 1.5 and about 2.5 hours, most preferably for about 2 hours. The expanded PUR may be dried by standing in air or by forcing air past it. The air may be heated. The expanded PUR may be dried under pressure.

The method according to the second aspect of the invention may further comprise a step to determine the water content of the dried expanded PUR.

The granulated PUR foam used in the invention may comprise recycled PUR foam. The granulated PUR foam may be previously prepared from PUR foam chunks also containing impurities such as aluminium and/or plastics material. The PUR foam chunks may be granulated using a granulator, using high pressure water jets pressurised at between 10.35 and 48.25 MPa, preferably 20.7 MPa, or by adding water and mixing in a high shear mixer. The mixer may preferably operate at between 2000 and 6000 rpm, most preferably at about 4000 rpm. The impurities may be removed by passing the granulated PUR through a mesh screen, preferably of between 75 μm and 4750 μm gauge, most preferably of about 2360 μm gauge.

There is further provided dried expanded PUR obtainable by a method according to the second aspect of the invention.

There is also provided a method for preparing a building material which comprises mixing a binding agent, water and dried expanded PUR obtainable by a method according to the second aspect of the invention, and building materials so produced. The components of the building material may be mixed in a high shear mixer. The binding agent may be cement or gypsum. The method may further comprise mixing at least one bulking agent, waterproofing agent and/or flowing agent with the other components of the mix. The bulking agent may be limestone dust or silica sand. The waterproofing agent may be Xypex admix C-1000. The flowing agent may be an air entrainer or a plasticiser. The components of the mix may be present in the quantities:

| | |
|---|---|
| Cement | 240-450 kg/m³ |
| PUR | 200-395 kg/m³ |
| Bulking agent | 0-300 kg/m³ |
| Waterproofing agent | 0.1-0.3% w/w cement |
| (Hydrophobe) | |
| Flowing agent | 0.03-0.06% w/w cement |
| (Airalon) | |
| Water | 160-450 l/m³ |

The components of the mix may preferably be present in the quantities:

| | |
|---|---|
| Cement | approx. 375 kg/m³ |
| PUR | approx. 250 kg/m³ |
| Bulking agent | approx. 250 kg/m³ |
| Waterproofing agent | 0.1-0.3% w/w cement |
| (Hydrophobe) | |
| Flowing agent | 0.03-0.06% w/w cement |
| (Airalon) | |
| Water | approx. 200 l/m³ |

Alternatively, the components of the mix may be present in the quantities:

| | |
|---|---|
| Cement | approx. 300 kg/m³ |
| PUR | approx. 327 kg/m³ |
| Waterproofing agent | 0.1-0.3% w/w cement |
| (Hydrophobe) | |
| Flowing agent | 0.03-0.06% w/w cement |
| (Airalon) | |
| Water | approx. 373 l/m³ |

According to a further aspect of the invention, there is provided a method of preparing a construction element comprising:
a) preparing a mould sized to reflect the intended dimensions of the construction element;
b) introducing a PUR building material comprising dried expanded PUR obtinable by a method according to the second aspect of the invention into the mould;
c) curing the so formed construction element; and
d) separating the mould and construction element.

Typically the construction element will be a panel board. Other construction elements include for example beams, spars and joists.

Preparing the mould may comprise laying glass fibre matting in the base of the mould and covering the matting with a layer of cementatious grout. The glass fibre matting may preferably be alkaline resistant. The cementatious grout layers may be 1-4 mm thick, preferably 1.5-2 mm thick, most preferably about 2 mm thick. The cementatious grout may have a plastic density of between 2000 and 2300 kg/m², preferably about 2180 kg/m² and have a cement content of between 400 and 500 kg/m³. The glass fibre matting may extend outside the mould. Following the pouring of the PUR building material into the mould, the glass fibre matting which extends outside the mould may be folded onto the non-mould facing surface of the PUR building material.

Preparing the mould may alternatively comprise spraying and rolling a layer of glass reinforced cement (GRC) into the base of the mould. The sprayed and rolled layer of GRC may be 14 mm thick, preferably 1.5-2 mm thick, most preferably about 2 mm thick. Glass fibre may be present in the GRC at about 2% w/w cementatious grout. Cementatious grout present in the GRC may have a plastic density of between 2000 and 2300 kg/m², preferably about 2180 kg/m² and a cement content of between 400 and 500 kg/m³. The GRC may be sprayed and rolled onto at least one ended mould piece and left for a period of time sufficient to allow the mix to set to form at least one GRC layer. Following the pouring of the PUR building material into the mould, the or each GRC layer may be folded onto the non-mould facing surface of the PUR building material.

After the PUR building material has been poured into the mould, the mould may be agitated to ensure uniform distribution within the mould of the PUR building material. The mould may be placed an a vibrating table to enable the agitation.

The method of preparing a construction element may further comprise:
a) the laying of the glass fibre matting over the non-mould facing surface of the poured PUR building material; and
b) the addition of a layer of cementatious grout over the top surface of the GRC matting.

The method may yet further comprise the trowel finishing of the cementatious grout layer. The glass fibre matting may preferably be alkaline resistant. The cementatious grout layer may be 1.5-2 mm thick. The cementatious grout may have a plastic density of between 2000 and 2300 kg/m², preferably about 2180 kg/m² and a cement content of between 400 and 500 kg/m³.

The method of preparing a construction element may alteratively further comprise the spraying and rolling of a layer of GRC onto the non-mould facing surface of the poured PUR building material. The method may yet further comprise the trowel finishing of the GRC layer. The sprayed and rolled layer of GRC may be 1.5-2 mm thick. Glass fibre may be present in the GRC at about 2% w/w cement grout. Cementatious grout present in the GRC may have a plastic density of between 2000 and 2300 kg/m², preferably about 2180 kg/m² and a cement content of between 400 and 500 kg/m³. The curing in the method of preparing a construction element may be air-curing for between 10 and 24 hours, preferably about 12 hours. Alternatively, the curing may be accelerated by curing in a mist chamber for between 6 and 15 hours, preferably about 8 hours.

There is further provided a construction element for use in construction obtainable by a method according to the invention.

There is further provided a building element comprising at least two construction elements which comprise dried expanded PUR obtainable by a method according to the second aspect of the invention. Typically, each construction element will be a panel board. The construction elements may be fixed together to maintain a void between each construction element. One or more voids may be filled with self compacting concrete, preferably reinforced concrete. One or more voids may be filled with air entrained concrete. The air entrained concrete may comprise PUR.

### BRIEF DESCRIPTION OF DRAWINGS

Embodiments of the invention will now be described by way of example only and with reference to the following FIGS. 1-8 in which:

FIG. 1 is a flow digram showing the stages in a method of producing grannulated PUR foam from recycled PUR foam briquettes;

FIG. 2 is a flow diagram showing the stages in a method of producing dried expanded PUR;

FIG. 3 shows a mould with glass fibre matting laid in the base and overlaid with a layer of cementatious grout;

FIG. 4 is a cross-section along the line A-A;

FIG. 5 shows a mould comprising extended mould pieces, with glass reinforced cement sprayed and rolled into the mould and onto the side extensions;

FIG. 6 shows a cross-section along the line B-B;

FIG. 7 is a flow diagram showing the stages in a method of producing a panel board constructed from PUR-containing building material; and

FIG. 8 is a cross-section through a two-void building element constructed using PUR-containing panel boards.

### MODES OF CARRYING OUT THE INVENTION

1. Preparing Granulated PUR Foam from PUR Foam Briquettes

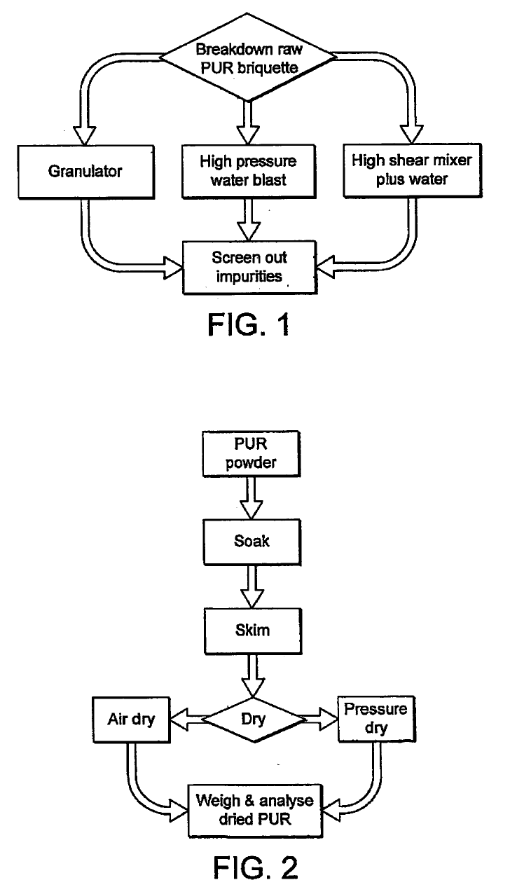

PUR foam briquettes are produced when, for example, refrigeration units containing PUR foam are dismantled. The briquettes are formed from recycled PUR foam and contain impurities, for example, plastic and aluminium fragments. A method for converting PUR briquettes into PUR suitable for use in the methods and materials according to the invention is outlined in FIG. 1.

The briquettes may first be broken down into granules using a granulator, such as a Getecha model RS3009 (Getecha UK Ltd, Warminster, Wiltshire, United Kingdom). Alternatively, they may be granulated using high pressure water jets, operating at a preferred pressure of 20.7 MPa. In a further alternative, the briquettes may be granulated by mixing with water and shredding in a high shear mixer, for example a GRC125 (2-speed) mixer (Power Sprays Ltd, Bristol, United Kingdom), typically operating at 4000 rpm.

The PUR granules, dry or wet depending on the method of granulation, are then passed through a screen, typically about 2360 μm gauge. This screen removes impurities such as pieces of plastic or aluminium, allowing cleaned granulated PUR to pass through.

2. Preparation of PUR for Use in Building Materials.

Cleaned PUR prepared as described in Example 1 above or by other preparation means, or alternatively newly manufactured PUR foam, is prepared for use in building materials by a method which is summarised in FIG. 2. The granulated PUR foam is soaked in potable water for about 2 hours. This period of time allows the PUR to fully expand to form PUR which will typically float to the surface of the water.

The expanded PUR is skimmed from the surface of the water. It is then dried, either by air drying or by drying under pressure. The expanded PUR may be air dried by leaving it to stand in air, or by passing air over it. The air may be heated or be at ambient temperature. Alternatively, the expanded PUR may be pressure dried by squeezing the PUR and draining the water away.

The dried expanded PUR is then weighed and analysed for remaining water content. This allows the calculation of he correct volume of water to be added when the dried expanded PUR is used in the mixing of building materials. This weighing and analysing step may be omitted once a typical water content, resulting from a given set of preparation conditions, is known.

3. Mixing of Building Materials Containing Dried Expanded PUR

Building materials containing dried expanded PUR may be cement based or gypsum based. Typical quantities of the components of such building materials are shown below, in Table 1:

TABLE 1
quantities of components of PUR-containing building material

| | | |
|---|---|---|
| Finished relative density | 0.97 | 0.6 |
| Cement | 375 kg/m³ | 300 kg/m³ |
| PUR | 250 kg/m³ | 327 kg/m³ |
| Limestone dust/ | 250 kg/m³ | 0 |
| silica sand | | |
| Waterproofing agent | 0.1-0.3% | 0.1-0.3% |
| (Hydrophobe) | w/w cement | w/w cement |
| Flowing agent (Airalon) | 0.03-0.06% | 0.03-0.06% |
| | w/w cement | w/w cement |
| Water | 200 l/m³ | 373 l/m³ |

The components of such building materials are mixed in a high-shear mixer, for example a GRC125 (2-speed) mixer as mentioned in Example 1 above.

4. Preparation of a Mould for the Production of PUR-Containing Panel Boards

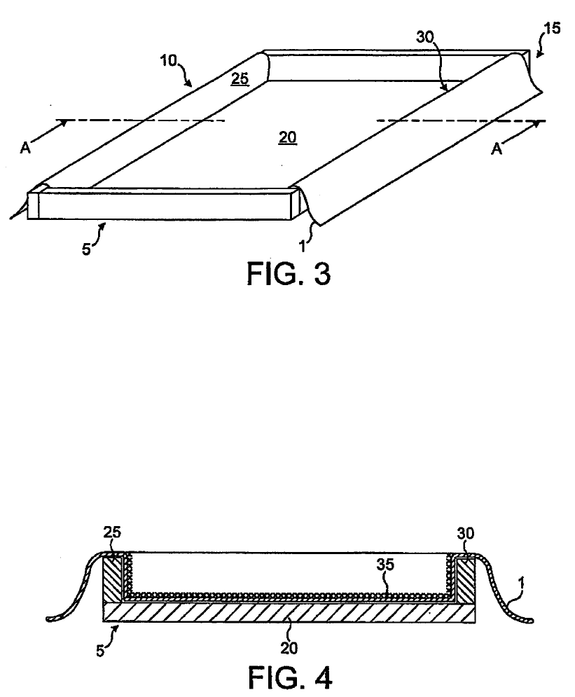

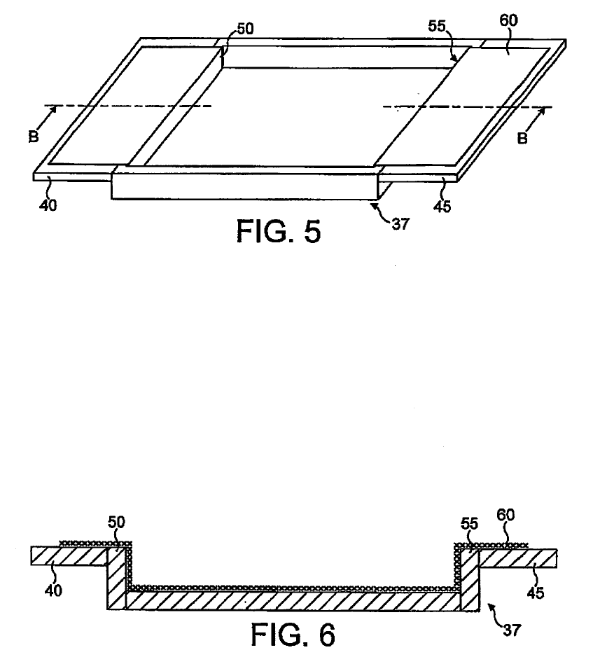

A mould, sized to reflect the finished board dimensions, is prepared in one of the two following ways:
a) As shown in FIGS. 3 and 4, a sheet of alkaline-resistant glass fibre matting (1) is laid in a mould (5), extending outside the mould on two opposite sides (10, 15) by approximately 70-100 mm. The matting lining the base (20) and sides (25, 30) of the mould is covered with an approximately 2 mm layer of cementatious grout (35), typically of plastic density of about 2180 kg/m² and cement content of between 400 and 500 kg/m³.
b) As shown in FIGS. 5 and 6, a mould (37) has extended mould pieces (40, 45) on two opposite sides (50, 55). A layer of glass-reinforced cement (GRC, glass fibre pre-mixed with cementatious grout) (60) is sprayed and rolled into the mould, also spraying the upper surfaces of the extended mould pieces with GRC up to 70-100 mm from the sides of the mould (50, 55). The glass fibre is typically present at about 2% w/w cementatious grout. The cementatious grout typically is of plastic density of about 2180 kg/m² and cement content of between 400 and 500 kg/m³.

The moulds may be prepared on a viewing table.

5. Preparation of PUR-Containing Panel Boards in Prepared Moulds.

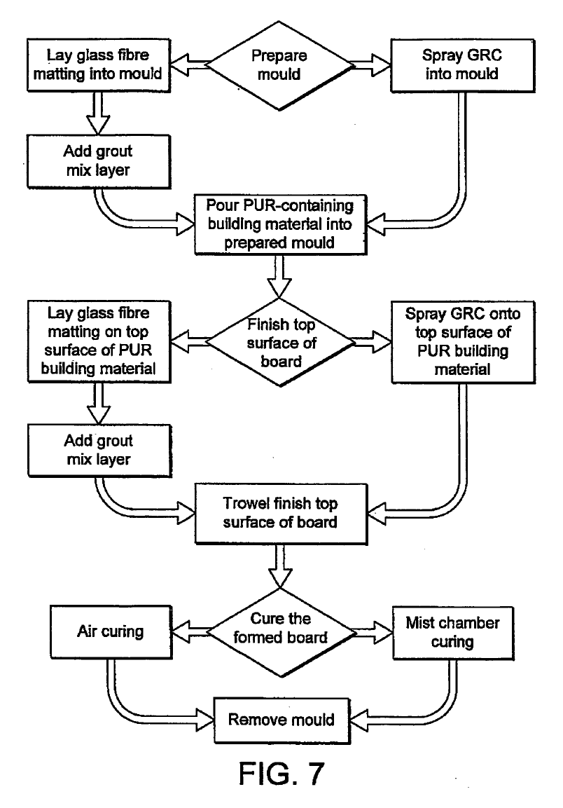

The preparation of PUR-containing panel boards is outlined in FIG. 7. A cement-based PUR-containing building material, of a composition described in Example 3 above, is introduced into a mould prepared as described in Example 4 above. The mould is then agitated to settle the PUR-containing building material and to remove any air bubbles. If the mould has been prepared on a vibrating table, the table may be vibrated to facilitate this agitation.

If the mould was prepared as described in Example 4a above, the lower layer of glass fibre matting which overlays the sides of the mould are folded in to make contact with the non-mould facing surface of the PUR-containing building material. A further layer of glass fibre matting is layered onto the non-mould fitting surface of the PUR-containing building material and the folded in lower layer of glass fibre matting. The top surface of the glass fibre matting is covered with an approximately 2 mm layer of cementatious grout, typically of plastic density of about 2180 kg/m² and cement content of between 400 and 500 kg/m³. The top surface of the cement grout is trowel finished to form the panel board's outer surface.

If the mould was prepared as described in Example 4b above, the lower GRC layer which was sprayed onto the extended mould pieces is folded in to make contact with the non-mould facing surface of the PUR-containing building material. A further layer of GRC is sprayed and rolled onto the non-mould facing surface of the PUR-containing building material and the folded in lower GRC layer. The glass fibre is typically present at about 2% w/w cementatious grout. The cementatious grout typically is of plastic density of about 2180 kg/m² and cement content of between 400 and 500 kg/m². The top surface of the GRC layer is trowel finished to form the panel board's outer layer.

The formed panel boards are next left to cure. Curing may be facilitated by air curing for between 10 and 24 hours, preferably for about 12 hours, or by mist chamber curing for between 6 and 15 hours, preferably about 8 hours, until the board is suitable for striking from the mould. Care should be taken, in particular in the case of air curing, to take appropriate steps to prevent surface crazing and cracking caused by high ambient temperature drying.

When the formed panel board has been suitably cured it is struck from the mould. The finished panel board product is suitable for various building applications. A panel board made using PUR-containing building material of for example, 0.85 final relative density is suitable for use in wall applications. A panel board made using PUR-containing building material of, for example, 0.97 final relative density is suitable for use in floor applications. By way of comparison, Aquapanel® has a final relative density of about 1.2.

6. Two-Void Building Element Constructed Using PUR-Containing Panel Boards

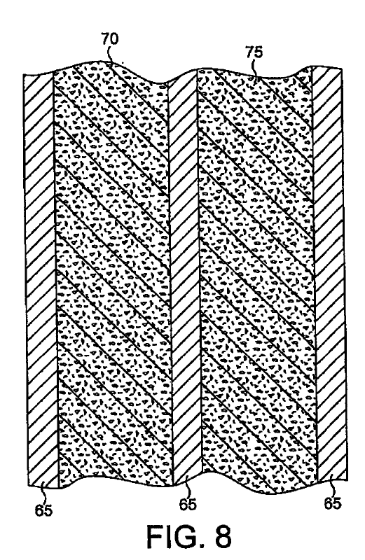

A two-void building element is constructed as shown in FIG. 8. Three PUR-containing panel boards (65) are fixed together by suitable ties, for example Rapid Bar Ties (RMD Kwikform, Walsall, UK), so as to maintain a void between each board.

The outer “structural” void (70) is filled with self compacting concrete which may be reinforced concrete. The inner “insulation” void (75) is filled with a lightweight air entrained concrete which may also contain PUR. The wall resulting from such a construction has good thermal insulation properties with U-values of 0.45 W/m²K or better.

### INDUSTRIAL APPLICABILITY

Products and methods in accordance with the invention can be used in industry, in particular, though not exclusively, in the construction industry.

1-15. (canceled)

16: A method for preparing dried expanded PUR for use in the preparation of concrete, comprising:
a) soaking granulated PUR foam in water for a period of time sufficient to allow the PUR to expand;
b) separating the PUR from the water, and
c) drying the PUR.

17: A method according to claim 16, wherein the water is between pH6 and pH9.

18: A method according to claim 17, wherein the water is potable.

19: A method according to claim 16, 17 or 18 wherein the PUR is soaked in water for between ten minutes and two days.

20: A method according to claim 19 wherein the PUR is soaked in water for between 1.5 and 2.5 hours.

21: A method according to claim 20 wherein the PUR is soaked in water for about 2 hours.

22: A method according to claim 16 wherein the expanded PUR is dried by standing in air.

23: A method according to claim 16 wherein the expanded PUR is dried by forcing air past it.

24: A method according to claim 22 or 23 wherein the air is heated.

25: A method according to claim 16 wherein the expanded PUR is dried under pressure.

26: A method according to claim 16 further comprising a step to determine the water content of the dried PUR.

27: A method according to claim 16 wherein the PUR comprises recycled PUR foam.

28: A method according to claim 27 wherein the PUR is previously prepared from PUR foam chunks also containing impurities such as aluminium and/or other plastics material.

29: A method according to claim 28 wherein the PUR foam chunks are granulated and the impurities removed.

30: A method according to claim 29 wherein the PUR foam chunks are granulated using a granulator.

31: A method according to claim 29 wherein the PUR foam chunks are granulated using high pressure water jets.

32: A method according to claim 31 wherein the water jets are pressurised at between 10.35 and 48.25 MPa.

33: A method according to claim 32 wherein the water jets are pressurised at about 20.7 MPa.

34: A method according to claim 29 wherein the chunks are granulated by adding water and mixing in a high shear mixer.

35: A method according to claim 34 wherein the mixer operates at between 2000 and 6000 rpm.

36: A method according to claim 35 wherein the mixer operates at about 4000 rpm.

37: A method according to claim 29 in which the impurities are removed by passing the granulated PUR foam through a mesh screen.

38: A method according to claim 37 in which the mesh screen is of between 75 μm and 4750 μm gauge.

39: A method according to claim 38 in which the mesh screen is of about 2360 μm gauge.

40: Dried expanded PUR obtainable by a method of claim 16.

41-102. (canceled)
